(19) United States
(12) Patent Application Publication
(10) Pub. No.: US 2024/0327302 A1
(43) Pub. Date: Oct. 3, 2024

(54) Setter For Firing Ceramic And Method For Producing The Same

(71) Applicant: Kabushiki Kaisha F.C.C., Hamamatsu-shi (JP)

(72) Inventors: Hiroaki YANO, Hamamatsu-shi (JP); Yuta SETO, Hamamatsu-shi (JP); Sho TANIGUCHI, Hamamatsu-shi (JP)

(21) Appl. No.: 18/740,022

(22) Filed: Jun. 11, 2024

Related U.S. Application Data
(63) Continuation of application No. PCT/JP2022/046144, filed on Dec. 15, 2022.

(30) Foreign Application Priority Data
Dec. 27, 2021 (JP) 2021-212244

(51) Int. Cl. C04B 38/00; C04B 41/00; C04B 41/45; F27D 5/00

(52) U.S. Cl. CPC C04B 38/0006; C04B 38/0051; C04B 41/0072; C04B 41/4578; F27D 5/0031

(57) ABSTRACT

A method of forming a setter for firing a ceramic has a sheet formation step (S1 to S3) to form a structure by sheet formation. The structure has a porous layer S1 with ceramic fibers. A shaping step S5 shapes the structure, into a predetermined shape. A coating step S6 impregnates the predetermined shape structure, with an impregnation liquid to form a dense layer S2 on the outer surface of the porous layer S1. The dense layer S2 is denser than the porous layer S1. A firing step S7, fires, at a predetermined temperature, the structure that has been subjected to the coating step S6.

### CROSS-REFERENCE TO RELATED APPLICATIONS

This application is a continuation of International Application No. PCT/JP2022/046144, filed Dec. 15, 2022, which claims priority to Japanese Application No. 2021-212244, Dec. 27, 2021. The disclosures of the above applications are incorporating herein by reference.

### FIELD

The present disclosure relates to a setter for firing a ceramic, and more particularly, to placing and firing a ceramic component on it and a method for producing the setter.

### BACKGROUND

In a firing step of firing a ceramic component, such as a ceramic capacitor, a green ceramic component is typically placed on a setter for firing a ceramic, and fired, for example, with a heater. An example of a conventional setter for firing a ceramic used in such firing is a setter with a porous body or inorganic fibers used to reduce the weight and the heat capacity as disclosed, for example, in Japanese Unexamined Patent Application Publication No. H3-1090.

### SUMMARY

Although the above conventional setter for firing a ceramic can be reduced in weight and heat capacity by using the porous body or inorganic fibers, the setter may be reduced in strength in accordance with the weight reduction. The setter for firing a ceramic is required to have high followability to a change in temperature (temperature followability). However, the conventional setter for firing a ceramic has a disadvantage of having insufficient temperature followability.

The present disclosure has been accomplished in view of the foregoing circumstances. It is an object of the present disclosure to provide a setter for firing a ceramic, with reduced heat capacity due to its reduced weight while maintaining its strength and having excellent temperature followability, and a method for producing the setter.

The disclosure provides a setter for firing a ceramic. The setter is used for placing and firing a ceramic component on it. It comprises a base including a porous layer where inorganic fibers are bonded to form a porous body.

The disclosure provides the base with a dense layer on the outer circumferential surface. The dense layer is denser than the porous layer.

The disclosure provides the base with a sheet-like base material formed in a planar shape and a corrugated base material formed by bending. The sheet-like base material and the corrugated base material are integrated in a laminated state to form a honeycomb structure.

The disclosure provides the porous layer with the inorganic fibers and a solidified inorganic portion formed by solidification of a powdery inorganic material. The inorganic fibers are bonded in a network form.

The disclosure provides that the inorganic fibers are composed of ceramic fibers.

The disclosure provides the porous layer of the base with a porosity of about 60%.

The disclosure provides a method for producing a setter for firing a ceramic where the setter is used for placing and firing a ceramic component on it. The method includes a sheet formation step of forming a structure by sheet formation. The structure includes therein a porous layer where inorganic fibers are contained to form a porous body. A shaping step forms the structure obtained in the sheet formation step into a predetermined shape. A coating step impregnates the structure formed into the predetermined shape in the shaping step with an impregnation liquid to form a dense layer on an outer surface of the porous layer. The dense layer is denser than the porous layer. A firing step fires, at a predetermined temperature, the structure that has been subjected to the coating step.

According to the disclosure, it is possible to provide a setter for firing a ceramic and a method for producing the setter. The setter has reduced heat capacity due to its reduced weight while maintaining its strength and having excellent temperature followability, because the setter includes the base with the porous layer where the inorganic fibers are bonded to form the porous body.

According to the disclosure, the base includes the dense layer on the outer circumferential surface. The dense layer is denser than the porous layer. Thus, the base can have further improved strength.

According to the disclosure, the base includes the sheet-like base material formed in a planar shape and the corrugated base material formed by bending. The sheet-like base material and the corrugated base material are integrated in a laminated state to form the honeycomb structure. This results in improved strength and porosity.

According to the disclosure, the porous layer includes the inorganic fibers and the solidified inorganic portion formed by solidification of the powdery inorganic material. The inorganic fibers are bonded in a network form. Thus, the porous layer can have a further improved porosity.

According to the disclosure, the inorganic fibers are composed of ceramic fibers. Thus, the thermal resistance can be further improved as compared with inorganic fibers composed of other materials.

According to the disclosure, the porous layer of the base has a porosity of about 60%. Thus, the weight reduction and strength improvement of the setter for firing a ceramic can be simultaneously and appropriately achieved.

According to the disclosure, the sheet formation step forms a structure by sheet forming. The structure includes the porous layer where the inorganic fibers are contained to form the porous body. The shaping step shapes the structure obtained in the sheet formation step into a predetermined shape. The coating step impregnates the structure formed into the predetermined shape, in the shaping step, with an impregnation liquid to form a dense layer on an outer surface of the porous layer. The dense layer is denser than the porous layer. The firing step, fires, at a predetermined temperature, the structure that has been subjected to the coating step. Thus, the setter, including the porous layer and the dense layer for firing a ceramic, can be easily produced.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a setter for firing a ceramic according to an embodiment of the present disclosure.

FIG. 2 is a schematic cross-sectional view of the setter for firing a ceramic.

FIG. 3 is a flowchart illustrating a method for producing the setter for firing a ceramic.

FIG. 4 is a schematic view of a sheet formation step in the production of the setter for firing a ceramic.

FIG. 5 is a table presenting setters for firing a ceramic (examples and comparative examples) according to embodiments of the present disclosure.

FIG. 6 illustrates photomicrographs of setters (a) with a dense layer formed and (b) with no dense layer formed for firing a ceramic according to embodiments of the present disclosure.

FIG. 7 is a graph of the technical superiority of a setter for firing a ceramic according to an embodiment of the present disclosure.

FIG. 8 is a graph of the technical superiority of a setter for firing a ceramic according to an embodiment of the present disclosure.

FIG. 9 is a schematic view of a setter for firing a ceramic according to another embodiment of the present disclosure.

FIG. 10 is a schematic view of a setter for firing a ceramic according to still another embodiment of the present disclosure.

### DETAILED DESCRIPTION

Embodiments of the present disclosure will be specifically described below with reference to the drawings.

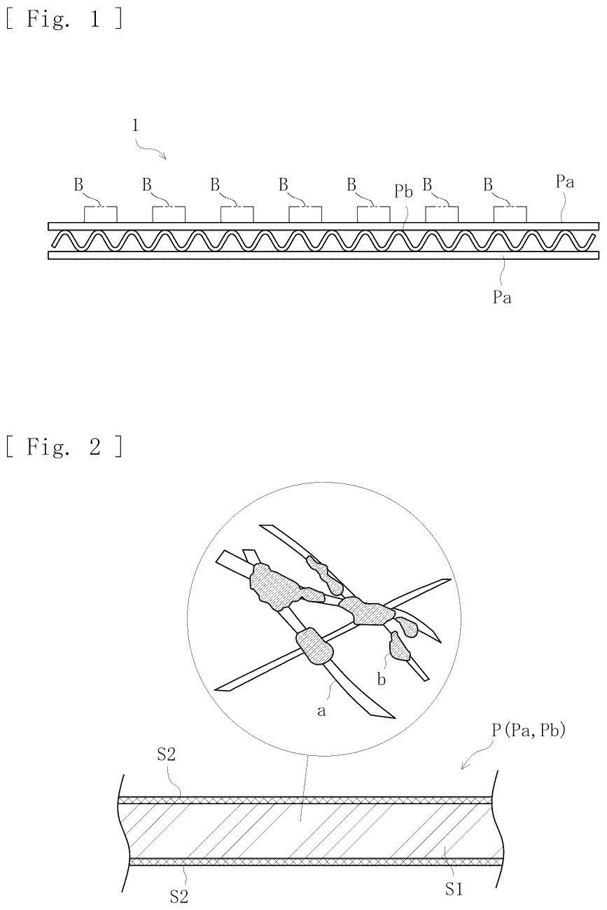

A setter 1 for firing a ceramic according to the present embodiment can be used for placing a plurality of ceramic components B on its surface and firing the ceramic components B using a heater while conveyed by a belt conveyor or the like with the ceramic components B placed on it. As illustrated in FIGS. 1 and 2, the setter includes sheet-like base materials Pa formed in a planar shape and a corrugated base material Pb formed by bending. The sheet-like base materials Pa and the corrugated base material Pb are integrated in a laminated state to form a honeycomb structure.

Specifically, as illustrated in FIG. 1, the setter 1, for firing a ceramic according to the present embodiment, has a honeycomb structure where the sheet-like base materials Pa, having a planar shape, are laminated and bonded on the upper surface and the lower surface of the corrugated base material Pb with an adhesive to form an integrated body. The corrugated base material Pb has been subjected to a bending process bending it into a wave form. The honeycomb structure may have a trough-shaped structure bent in a triangular shape, or the like, in addition to a corrugated structure bent in a wave form as in the present embodiment.

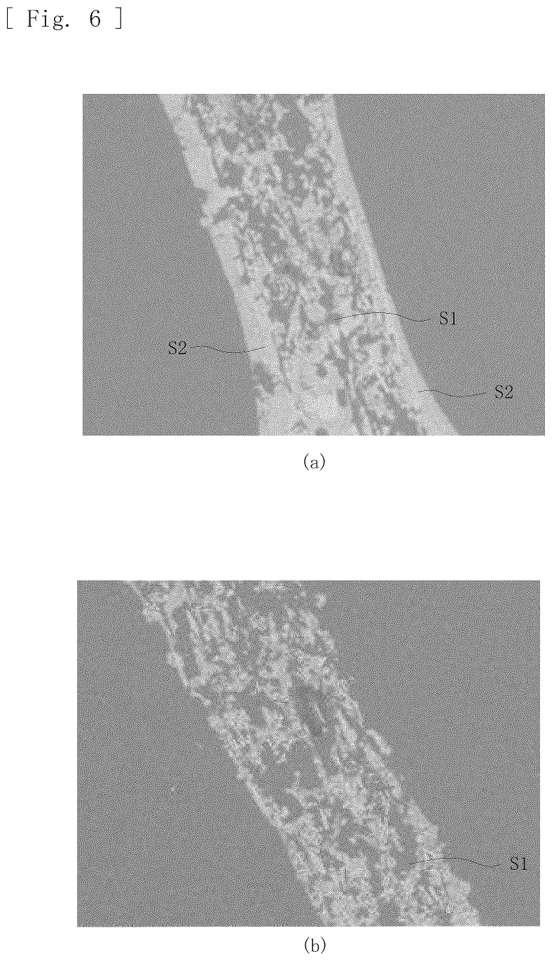

As illustrated in FIGS. 2 and 6 (a), the base P (the sheet-like base materials Pa and the corrugated base material Pb) constituting the setter 1 for firing a ceramic includes a porous layer S1 and a dense layer S2. The porous layer S1 includes ceramic fibers (inorganic fibers) that are bonded to form a porous body. The dense layer S2 is denser than the porous layer S1. As illustrated in FIG. 2, the porous layer S1 contains ceramic fibers (a) (inorganic fibers) and solidified inorganic portions (b) formed by solidifying a powdery inorganic material. The ceramic fibers (a) (inorganic fibers) are bonded in a network shape.

As illustrated in FIG. 6 (a), the dense layer S2 is disposed on the outer circumferential surface of the base P (the outside of the porous layer S1). It is composed of a layer denser than the porous layer S1. Also, it is formed by impregnating the outer circumferential portion of the base P with a predetermined coating material in the present embodiment. An example of the coating material constituting the dense layer S2 is a material prepared by mixing a plurality of components including a ceramic powder at a predetermined ratio. However, a material that does not contain a ceramic powder may be used as long as the material is capable of forming a dense layer.

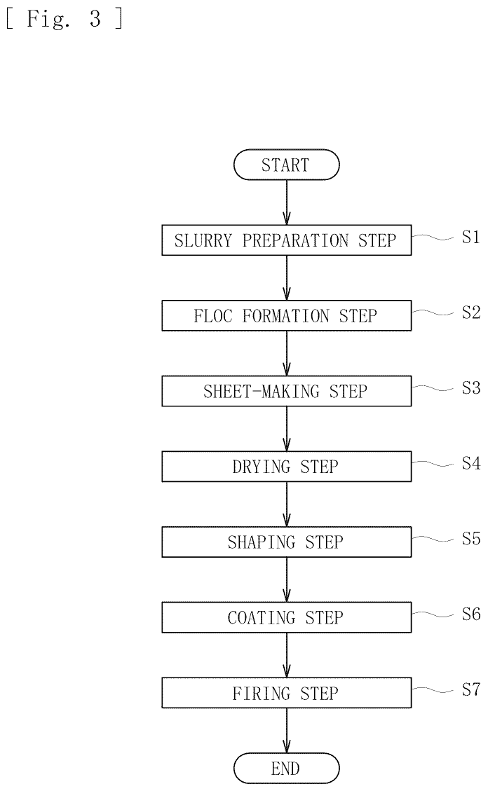

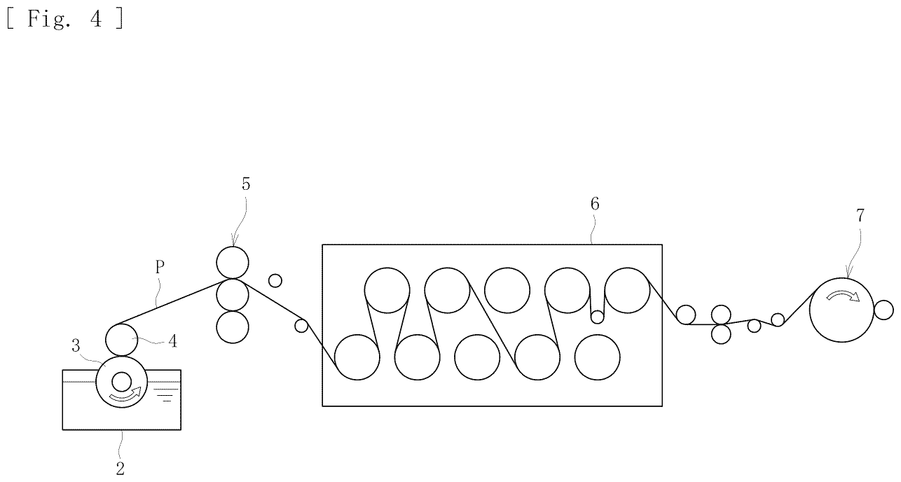

A method for producing the setter 1 for firing a ceramic according to the present embodiment will be described below with reference to the flowchart of FIG. 3.

Ceramic fibers, a ceramic powder, organic fibers, an organic binder (binding agent), a pore regulator, and so forth are added to a predetermined amount of water to prepare an aqueous dispersion, and a slurry containing these materials uniformly dispersed is prepared (slurry preparation step S1). Then, a flocculant is added to the slurry to form flocs (floc formation step S2). Then the flocs are subjected to a papermaking process (wet papermaking process) to form a sheet-like (paper-like) porous structure (sheet-making step S3).

The ceramic fibers and the ceramic powder are composed of alumina or mullite in the present embodiment. The amount of ceramic fibers contained based on the ceramic powder is preferably adjusted in the range of 50% to 200% by weight. The ceramic powder is not limited to those composed of the same material as the ceramic fibers, as described in the present embodiment. The ceramic powder may be composed of a material different from the ceramic fibers.

The flocculant for forming flocs contains a polymer flocculant and metal cations. It has a strong electric charge and neutralizes the electric charge of substances that are electrically charged and electrically repel each other in an aqueous solution. This serves to strongly entangle the substances. The polymer flocculant has the function of penetrating between the entangled fibers to further increase the bonding strength. Regarding the metal cations, an Al³⁺ cation-containing aqueous solution of alum, aluminum sulfate, or the like is used.

In the present embodiment, as illustrated in FIG. 4, a predetermined amount of flocs containing the alumina fibers, the binder, and so forth (flocs formed through the slurry preparation step S1 and the floc formation step S2) is stored in a storage container 2. The flocs are scooped up by a cylinder mold 3, a net-like member for allowing a predetermined amount of slurry to adhere to the outer circumferential surface and conveying the slurry to a roller 4. The mold is rotationally driven in a range from above to below the liquid surface in the storage container 2, thereby providing a sheet-like structure having a predetermined thickness. The sheet-like structure is sequentially and continuously conveyed from the roller 4 to a roll press 5. It is adjusted to have a desired thickness by applying a predetermined pressure in the roll press 5.

The sheet-like structure, which has been adjusted to have a predetermined thickness, by applying a pressure with the roll press 5, is continuously sent to a dryer 6. It is subjected to a drying process while being conveyed in the dryer 6 (drying step S4). Thereafter, the dried sheet-like structure is sequentially wound by a winder 7. The slurry preparation step S1 to the sheet-making step S3 are included in the sheet formation step of forming the sheet-like structure including therein the porous layer S1 where the ceramic fibers are contained to form the porous body by sheet formation (papermaking).

The sheet-like structure that has been subjected to the drying step S4, after the sheet formation step, is shaped into a predetermined shape in a shaping step S5. The shaping step S5 is a step of shaping the sheet-like structure (base P) wound up by the winder 7 and cut to predetermined dimensions into a honeycomb structure. As illustrated in FIG. 1, the shaping step S5 is a step of laminating sheet-like base materials Pa having a planar shape on the upper surface and the lower surface of the corrugated base material Pb, which has been subjected to a bending process into a wave form, and integrating them by bonding with an adhesive.

After the shaping step S5, a coating step S6 is performed. The coating step S6 is a step of impregnating the structure that has been shaped into a predetermined shape (honeycomb shape) in the shaping step S5, with an impregnation liquid. In the present embodiment, the coating step S6 is a step of mixing water, a ceramic powder, a thickener, a dispersant, and so forth in a predetermined ratio to prepare a coating material. Then impregnate the structure that has been shaped into the predetermined shape (honeycomb shape) in the shaping step S5, with the coating material.

Finally, the structure impregnated with the coating material in the coating step S6 is fired in a firing step S7. The firing step S7 is a step of firing, at a predetermined temperature, the structure that has been subjected to the coating step S6. In the present embodiment, the setter 1, composed of the base P (the sheet-like base materials Pa and the corrugated base material Pb), for firing a ceramic can be produced by firing at a temperature of 1,300° C. to 1,550° C. in a firing furnace.

The setter 1 for firing a ceramic obtained as described above is composed of the base including the porous layer S1 where the ceramic fibers are bonded to form a porous body and the dense layer S2 denser than the porous layer S1. As illustrated in FIG. 2, the porous layer S1 contains the ceramic fibers and the solidified inorganic portions formed by solidifying the powdery inorganic material. The ceramic fibers are bonded in a network shape. The porous layer S1 of the base (the sheet-like base materials Pa and the corrugated base material Pb) according to the present embodiment has a porosity (voidage) of about 60%.

Experimental results indicating the technical superiority of the setter 1 for firing a ceramic according to the present embodiment will be described below.

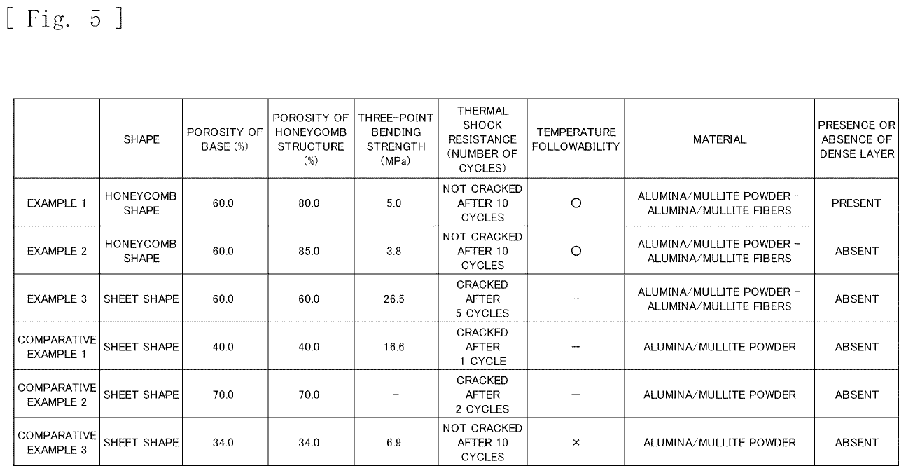

First, Examples 1 to 3 and Comparative Examples 1 to 3 presented in the table of FIG. 5 were prepared.

### Example 1

A material containing an alumina powder or a mullite powder and a material containing alumina fibers or mullite fibers were mixed. The resulting mixture was subjected to a sheet formation step, a shaping step, a coating step, and a firing step to produce a honeycomb shape of Example 1. In Example 1, the porosity of the base is 60%, and the porosity in consideration of the shape (the porosity of the entire honeycomb shape) is 85%. In addition, as illustrated in FIG. 6 (a), the porous layer S1 and the dense layer S2 are formed in the base P (the sheet-like base materials Pa and the corrugated base material Pb).

### Example 2

A material containing an alumina powder or a mullite powder and a material containing alumina fibers or mullite fibers were mixed. The resulting mixture was subjected to a sheet formation step, a shaping step, and a firing step to produce a honeycomb shape of Example 2. In Example 2, the porosity of the base is 60%, and the porosity in consideration of the shape (the porosity of the entire honeycomb shape) is 80%. As illustrated in FIG. 6 (b), although the porous layer S1 is formed in the base P (the sheet-like base materials Pa and the corrugated base material Pb), the dense layer S2 is not formed because impregnation with the coating material (impregnation material) is not performed.

### Example 3

A material containing an alumina powder or a mullite powder and a material containing alumina fibers or mullite fibers were mixed. The resulting mixture was subjected to a sheet formation step and a firing step to produce a sheet shape of Example 3. In Example 3, the porosity of the base is 60%, and only the sheet-like base material Pa is used (a honeycomb shape is not used because the corrugated base material Pb is not bonded). As illustrated in FIG. 6 (b), although the porous layer S1 is formed in the base P (sheet-like base material Pa), the dense layer S2 is not formed because impregnation with the coating material (impregnation material) is not performed.

### Comparative Example 1

A material containing an alumina powder or a mullite powder was mixed. The resulting mixture was subjected to a sheet formation step and a firing step to produce a sheet shape of Comparative Example 1. In Comparative Example 1, the porosity of the base is 40%, and only the sheet-like base material Pa is used (a honeycomb shape is not used because the corrugated base material Pb is not bonded). The porous layer S1 and the dense layer S2 are not formed in the base P (sheet-like base material Pa) because both alumina and mullite fibers are not contained and impregnation with a coating material (impregnation material) is not performed.

### Comparative Example 2

A material containing an alumina powder or a mullite powder was mixed. The resulting mixture was subjected to a sheet formation step and a firing step to produce a sheet shape of Comparative Example 2. In Comparative Example 2, the porosity of the base is 70%, and only the sheet-like base material Pa is used (a honeycomb shape is not used because the corrugated base material Pb is not bonded). The porous layer S1 and the dense layer S2 are not formed in the base P (sheet-like base material Pa) because both alumina and mullite fibers are not contained and impregnation with a coating material (impregnation material) is not performed.

### Comparative Example 3

A material containing an alumina powder or a mullite powder was mixed. The resulting mixture was subjected to a sheet formation step and a firing step to produce a sheet shape of Comparative Example 3. In Comparative Example 3, the porosity of the base is 34%, and only the sheet-like base material Pa is used (a honeycomb shape is not used because the corrugated base material Pb is not bonded). The porous layer S1 and the dense layer S2 are not formed in the base P (sheet-like base material Pa) because both alumina and mullite fibers are not contained and impregnation with a coating material (impregnation material) is not performed.

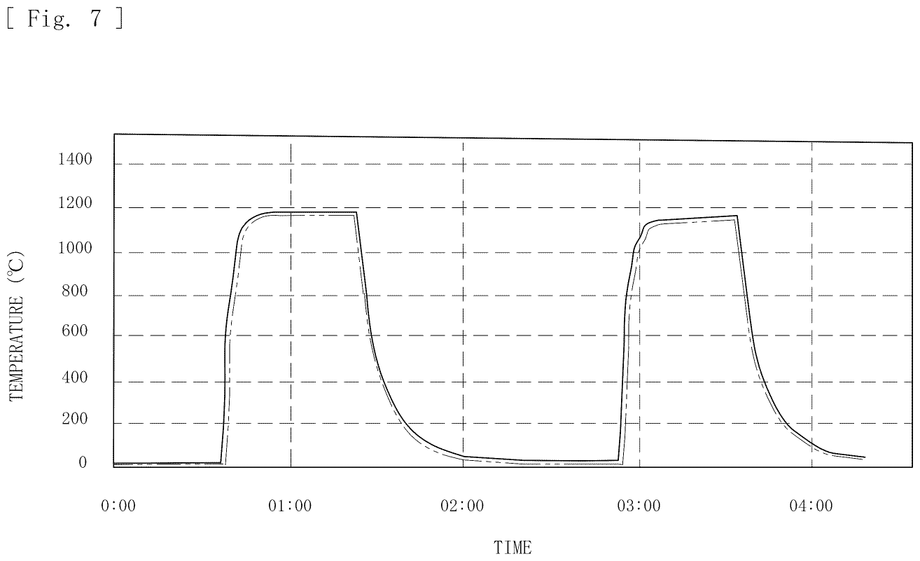

Examples 1 to 3 and Comparative Examples 1 to 3 were placed on an Amsler testing machine and subjected to a three-point bending strength test. The results presented in FIG. 5 were obtained. The experimental results indicated that Example 3 had the highest strength. Subsequently, Examples 1 to 3 and Comparative Examples 1 to 3 were rapidly heated with a gas burner. The superiority or inferiority of the thermal shock resistance was observed. In this experiment, heating was performed with the gas burner so as to obtain a heat curve as illustrated in FIG. 7. The results revealed that Examples 1 and 2 and Comparative Example 3 did not exhibit any cracks even after 10 cycles of the heat curve, indicating their high thermal shock resistance.

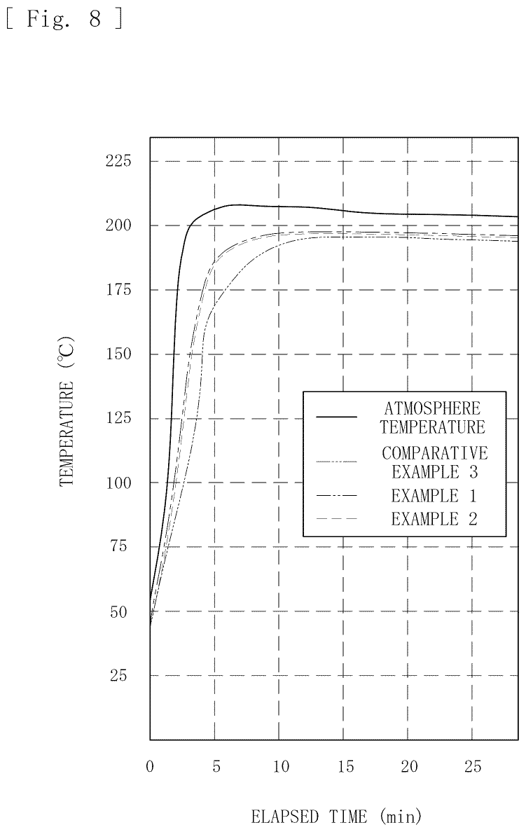

Finally, an experiment was conducted on temperature followability for Examples 1 and 2 and Comparative Example 3, which exhibited high thermal shock resistance. In this experiment, the temperature followability was observed by measuring the temperature of an atmosphere in the electric furnace and the surface temperatures of Examples 1 and 2 and Comparative Example 3 while the temperature in the electric furnace was changed. The results illustrated in FIG. 8 revealed that the temperature followability was higher in Examples 1 and 2 than in Comparative Example 3.

According to the present embodiment, it is possible to provide the setter 1 for firing a ceramic and the method for producing the same. The setter includes the base P including therein the porous layer S1 where the ceramic fibers are bonded to form a porous body. Thus, it has reduced heat capacity due to its reduced weight while maintaining its strength and having excellent temperature followability. In particular, the base P according to the present embodiment includes the dense layer S2 denser than the porous layer S1 on the outer circumferential surface and thus can have further improved strength.

In addition, the base P according to the present embodiment includes the sheet-like base materials Pa formed in a planar shape and the corrugated base material Pb formed by bending. The sheet-like base materials Pa and the corrugated base material Pb are integrated in a laminated state to form the honeycomb structure, which can result in improved strength and porosity. Furthermore, the porous layer S1, according to the present embodiment, has the ceramic fibers (inorganic fibers) and the solidified inorganic portions formed by solidifying the ceramic powder (powdery inorganic material). The ceramic fibers are bonded in a network shape. Thus, the porous layer S1 can have further improved porosity.

Furthermore, since the inorganic fibers according to the present embodiment are composed of the ceramic fibers, the thermal resistance can be further improved as compared with inorganic fibers composed of other materials. In particular, the porous layer S1 of the base P according to the present embodiment has a porosity of about 60%. Thus, it is possible to simultaneously and appropriately achieve the weight reduction and the strength improvement of the setter 1 for firing a ceramic.

According to the present embodiment, the method includes the sheet formation step (the slurry preparation step S1, the floc formation step S2, and the sheet-making step S3) of forming the structure by sheet formation. The structure includes the porous layer where the inorganic fibers are contained to form a porous body, the shaping step S5 of shaping the structure obtained in the sheet formation step into a predetermined shape (honeycomb shape). The coating step S6 impregnates the structure, formed into the predetermined shape in the shaping step S5, with the impregnation liquid to form the dense layer S2 on the outer surface of the porous layer S1. The dense layer S2 is denser than the porous layer S1. The firing step S7, fires, at a predetermined temperature, the structure that has been subjected to the coating step S6. Thus, it is possible to easily provide the setter 1 for firing a ceramic. The setter includes the porous layer S1 and the dense layer S2.

Although the present embodiment has been described above, the present disclosure is not limited thereto. For example, other inorganic fibers may be used instead of the ceramic fibers, the dense layer S2 need not be provided, a structure different from the honeycomb structure may be used, or a different porosity may be used. The impregnation liquid (coating agent) used in the coating step S6 may be another material capable of forming the dense layer S2, or the conditions (for example, the firing temperature) in the firing step S7 may be other conditions.

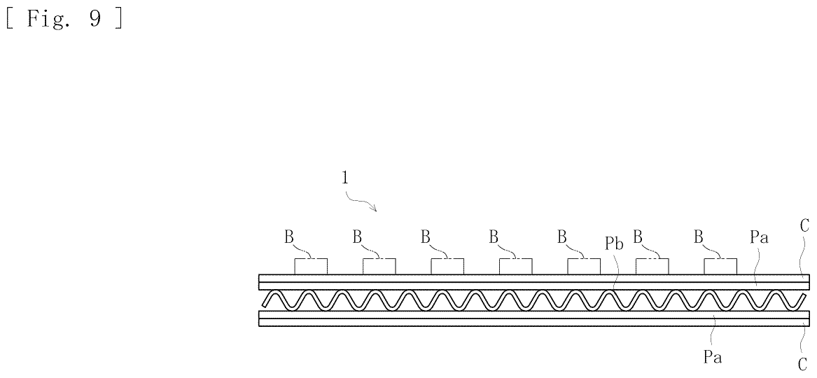

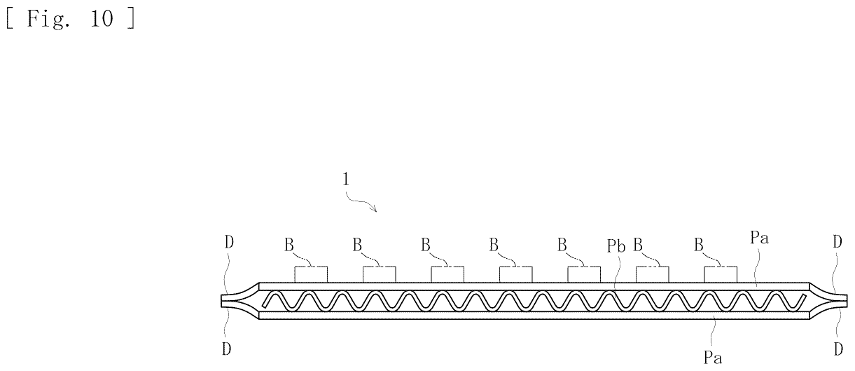

Furthermore, as illustrated in FIG. 9, surface layers C may be formed on the surfaces of the sheet-like base materials Pa (each of the upper and lower sheet-like base materials Pa) in order to inhibit a reaction between the setter 1 for firing a ceramic and ceramic components B placed on the surface and to prevent the setter 1 for firing a ceramic from being contaminated. The surface layers C are composed of a material, such as zirconia, yttria, or alumina, and can be formed by application of the material or immersion with the material after the coating step S6 or the firing step S7. To inhibit the end face from being chipped at the time of handling, as illustrated in FIG. 10, seals D may be formed on the end faces of the setter 1 for firing a ceramic. Silica may be contained as a sintering aid.

A setter having another configuration for firing a ceramic and produced by another production method can also be applied as long as it includes a base including a porous layer where inorganic fibers are bonded to form a porous body.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A setter for firing a ceramic, the setter is used for placing and firing a ceramic component on it, comprising:
a base including therein a porous layer where inorganic fibers are bonded to form a porous body.

2. The setter for firing a ceramic according to claim 1, wherein the base includes a dense layer on an outer circumferential surface, the dense layer being denser than the porous layer.

3. The setter for firing a ceramic according to claim 1, wherein the base includes a sheet-like base material formed in a planar shape and a corrugated base material formed by bending, and the sheet-like base material and the corrugated base material are integrated in a laminated state to form a honeycomb structure.

4. The setter for firing a ceramic according to claim 1, wherein the porous layer includes the inorganic fibers and a solidified inorganic portion formed by solidification of a powdery inorganic material, and the inorganic fibers are bonded in a network form.

5. The setter for firing a ceramic according to claim 1, wherein the inorganic fibers include ceramic fibers.

6. The setter for firing a ceramic according to claim 1, wherein the porous layer of the base has a porosity of about 60%.

7. A method for producing a setter for firing a ceramic, the setter is used for placing and firing a ceramic component on it, the method comprising:
a sheet formation step of forming a structure by sheet formation, the structure including a porous layer in which inorganic fibers are contained to form a porous body;
a shaping step of shaping the structure obtained in the sheet formation step into a predetermined shape;
a coating step of impregnating the structure formed into the predetermined shape in the shaping step with an impregnation liquid to form a dense layer on an outer surface of the porous layer, the dense layer being denser than the porous layer; and
a firing step of firing, at a predetermined temperature, the structure that has been subjected to the coating step.
